(19) United States
(12) Patent Application Publication
(10) Pub. No.: US 2010/0114832 A1
(43) Pub. Date: May 6, 2010

(54) Forensic snapshot

(76) Inventors: Mark D. Lillibridge, Mountain View, CA (US); Kimberly Keeton, San Francisco, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/290,617

(22) Filed: Oct. 31, 2008

(51) Int. Cl. G06F 17/30; G06F 7/00

(52) U.S. Cl. 707/649; 707/E17.044

(57) ABSTRACT

Systems, methods, and other embodiments associated with forensic snapshots are described. One example method includes creating a snapshot of an operational data. The example method may also include creating a hash tree by hashing lowest level data blocks of the snapshot to produce lowest level hashes. Creating a hash tree may also include repeatedly growing the hash tree bottom up by selectively hashing lower level hashes into higher level hashes until a root node is produced. The example method may also include providing a forensic data associated with the hash tree, where the forensic data is used to verify the integrity of the snapshot.

### BACKGROUND

In recent decades, data systems have become increasingly more important to businesses and government for information storage. Every year a greater percentage of company information is stored on these data systems as opposed to traditional paper files. In some cases, entire offices have become paperless by relying completely on data systems alone for information storage. Data systems may store information related to emails, order tracking, customer relationship management, product design information, production engineering information, and so on. As the amount of data collected by data systems increases, so too does the need to provide this information to outside parties. For example, adverse parties such as civil litigants or government investigators will often request, subpoena, or serve search warrants to acquire information from a data system.

However, the requirements for providing data from the data system may be burdensome if, for example, the adverse party demands that the data system be frozen when the subpoena is served until a copy is made to prevent changes or deletions in the information. This may be a major issue because businesses cannot afford to go hours, let alone days, without updating their data systems while the system is frozen for information copying. Additionally, the large amounts of data that are often requested in an initial subpoena may be unreasonably broad and include data that is not relevant to the conflict. This is because subpoenas often cannot be challenged until the owner of the data system is notified of the demand for information that may not occur until the subpoena is served. Thus, subpoenas for data system information may prevent updates to the data system while the system is frozen for copying. Initial subpoenas may simply demand too much irrelevant data.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of an example method associated with forensic snapshots.

FIG. 2 illustrates one embodiment of another example method associated with forensic snapshots.

FIG. 3 illustrates one embodiment of another example method associated with forensic snapshots.

FIG. 4 illustrates one embodiment of an example system associated with forensic snapshots.

FIG. 5 illustrates one embodiment of another example method associated with forensic snapshots.

FIG. 6 illustrates one embodiment of an example hash tree associated with forensic snapshots.

FIG. 7 illustrates one embodiment of an example computing environment in which example systems and methods, and equivalents, may operate.

### DETAILED DESCRIPTION

Snapshots may offer an alternative to freezing a data system by preserving a copy of data at the time of the snapshot while allowing updates to the data system. By creating an almost instantaneous copy of the data system, a snapshot allows for continuation of business operations as opposed to a freeze out from the data system until a copy is created. The almost instantaneous creation of the snapshot and the preservation of the data of the snapshot allow a copy of the snapshot to be made in the background of the data system to conserve system resources. However, snapshots may still be subject to deliberate manipulations between the time the snapshot is performed and the time a copy of the snapshot is provided to a requesting party. Thus, a snapshot alone may not satisfy a data integrity standard associated with, for example, regulations, litigation, and so on.

Hash trees may be used with snapshots to verify a later provided copy of the snapshot. Hash trees of snapshots may be created faster than a copy of the snapshot. A copy of the snapshot may then be created in the background thereby conserving system resources and preventing the need to freeze the data system while the copy is created. For example, once a plaintiff has a copy of the root node of the hash tree associated with a snapshot, it is very difficult to manipulate the snapshot without detecting the manipulation. Due to the speed of the different approaches to calculating the hash tree, the ability to manipulate the snapshot data may be minimized. For example, plaintiff may serve a subpoena on Burger Joint Inc. to gather information relating to its class action suit alleging that Burger Joint Inc. uses too much fat in its burgers causing people to become overweight. To determine that the data of Burger Joint Inc. is not altered by unscrupulous individuals after the subpoena is served, the plaintiff may demand a root node of the hash tree of the snapshot. The root node may be used to verify the later provided copy of the snapshot. Additionally, the root node of the hash tree does not reveal the information of the data system. However, it may be used to verify the information. This may allow Burger Joint Inc. the time to argue to limit the scope of electronic discovery to prevent disclosure of its secret sauce formula that makes its burgers so tasty while still providing verifiable data integrity. The root node of the hash tree may then be used to verify a portion of the snapshot that is determined to be relevant to the conflict.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: static RAM.

ROM: read only memory.

PROM: programmable ROM.

EPROM: erasable PROM.

EEPROM: electrically erasable PROM.

SQL: structured query language.

OQL: object query language.

USB: universal serial bus.

WAN: wide area network.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Query”, as used herein, refers to a semantic construction that facilitates gathering and processing information. A query may be formulated in a database query language (e.g., SQL), an OQL, a natural language, and so on.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produces a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

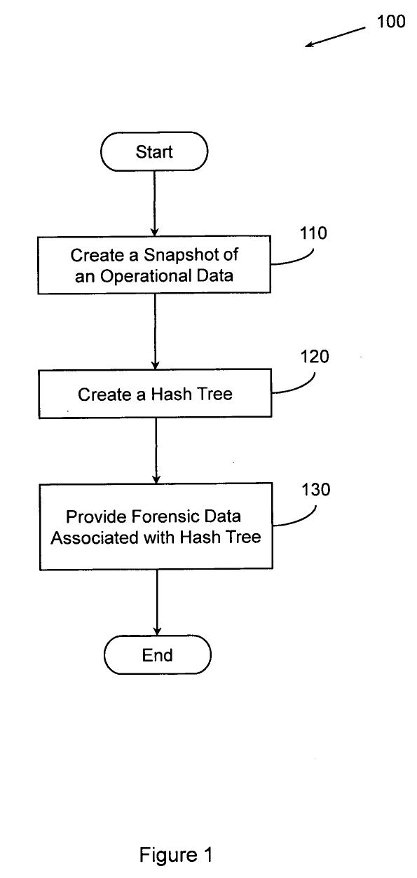

FIG. 1 illustrates a method 100 associated with forensic snapshots. Method 100 may include, at 110, creating a snapshot of an operational data collection. Operational data may include, but is not limited to, a database, a portion of a database, one or more database tables, a set of documents, a sequence of bytes, and so on. An operational data collection may include operational data. The operational data may be stored in an operational data store. Creating a snapshot of a collection of data involves quickly creating an immutable logical copy of the original collection that preserves the state of the original collection at the time of the snapshot even though the original collection may continue to be modified. The operational data collection continues to be available to an application without interruption after the snapshot is performed. This may allow applications to continue to update operational data while maintaining a copy of the data at the time of the snapshot. This allows a business that is dependent upon the data system to continue with normal uninterrupted operations.

Methods for creating a snapshot are known. For example, data collections, including the original collection and snapshots taken, may be represented as directed acyclic graphs (DAGs) of blocks. The blocks may be shared. When a snapshot is initially created, the root node of the original collection is copied. Other blocks are shared. When the original collection later needs to be changed, the block to be modified is first made unshared by duplicating it, and its parents if necessary, and associating one copy with the original collection and one copy with the others. This technique is called copy-on-write. While copy-on-write has been described, one skilled in the art will appreciate that snapshot implementations may also use techniques including a re-direct on write, a split mirror, and so on. A forensic snapshot may facilitate verifying that certain data associated with the snapshot has not changed since the snapshot was taken.

The operational data collection may include metadata in addition to or instead of data files or items. Metadata may be the data about a file system structure and the files. Metadata may include a file system structure of a file system, a file system structure of a subdirectory of a file system, a header of a file, and so on. Metadata is becoming an increasingly important part of court ordered electronic discovery. File system metadata derived from electronic files may be important evidence. Additionally, the Federal Rules of Civil Procedure may make metadata discoverable as part of litigation. In some examples, a snapshot of metadata or just the metadata portion of a snapshot may be provided without providing data files. A separate hash tree and root node may be created for the metadata alone because a snapshot and a hash tree of the metadata may be computed and created faster than for the data files. The snapshot of the metadata may allow a judge to review the file system structure to determine the appropriate scope of electronic discovery. For example, a plaintiff may request the entire database of Burger Joint in connection with a law suit involving a single franchise. Burger Joint counsel may utilize a verifiable copy of the metadata showing the file system structure to illustrate that the information that is relevant to the dispute is available in a subdirectory of the data system.

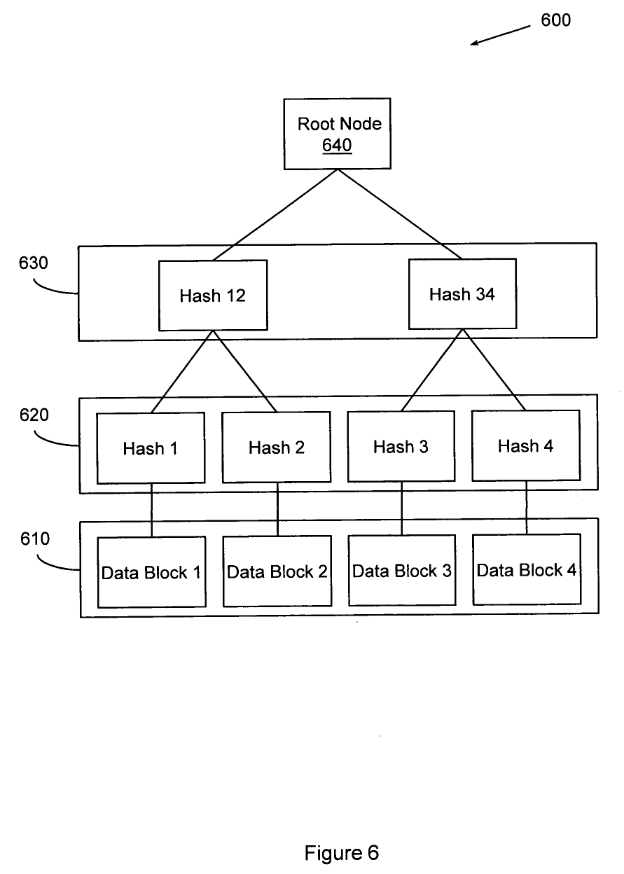

Method 100 may also include, at 120, creating a hash tree from the snapshot of the operational data collection. A hash tree may be a data structure in the form of a tree of hashes and blocks of data. For an illustration of a hash tree see FIG. 6, which is described below. A hash tree may be depicted as an inverted tree or upside down tree. Leaves of the tree are located at the bottom while the root node of the tree is located at the top. The leaves of the hash tree may include blocks of data that may include a file, a set of files, a data block, a disk block, a data cluster, a metadata, a file system structure, and so on. Non-leaf nodes may include hashes of all their children. In this way, the hash of a node is effectively a hash of the entire tree rooted at that node. At the top of the tree is a root. Non-leaf nodes may also include metadata or data. Many hash trees use binary implementations that include at most two children per node but one skilled in the art will recognize that hash trees may also use many more child nodes under each parent node. Hash trees and/or nodes or hashes of nodes of hash trees may be used to make sure that blocks of data (e.g. leaves of the hash tree) received from adverse parties are unaltered during the copying of data blocks.

Creating a hash tree at 120 may include hashing data blocks that are part of the snapshot. Hashing data blocks may produce lowest level hashes. Data blocks may include a file, a data block, a disk block, a data cluster, and so on. A hash tree without its leaves may be a summary of information about a larger piece of data contained in its leaves, for example, a file or a file system. The hash tree without its leaves may be used to verify the contents of the larger piece of data. It is understood by one skilled in the art that a hash tree may also be a Merkle tree.

Creating a hash tree at 120 may also include repeatedly growing the hash tree bottom up by selectively hashing lower level hashes into higher level hashes until a root node is produced. Checking the integrity of a data block involves accessing its parents in the hash tree. This minimal data requirement may reduce processing since it may only be necessary to copy and verify a portion of the hash tree and its associated portion of the snapshot rather than an entire structure.

In one embodiment, repeatedly growing the hash tree bottom up includes hashing multiple hashes of lower level data blocks to produce an intermediate level hash that is at a lower level of the hash tree than the root node. The intermediate level hash may also be used in combination with its parent nodes to verify the integrity of a portion of the snapshot. Intermediate level hashes may be, for example, hashes in an intermediate level block of hashes 630 of FIG. 6.

Method 100 may also include, at 130, providing a forensic data associated with the hash tree. The forensic data may be used later to verify the integrity of provided portions of the snapshot and/or of portions of a snapshot that someone offers as being the provided portion of the snapshot. There are at least two cases where verification is undertaken. A first case arises when a party wants to verify that the data they are receiving at a later point accurately reflects the data for which a snapshot was taken and for which the hash was created. A second case arises when a party wants to verify that data they received at an earlier point is identical to data being received at a later point. Verifying the integrity means determining that the provided data is identical to the corresponding data at the time of the snapshot. The integrity of the provided portions of the snapshot may be verified with the associated portions of the hash tree and the forensic data. “Forensic data”, as used herein, refers to data from which an integrity determination may be made. In one example, the forensic data may be a hash tree created at the time a snapshot is created minus its leaf nodes. In another example, the forensic data may be just a node (e.g., root node) of the hash tree or its hash. The snapshot data, or subsets of the snapshot data, may subsequently be provided to a reviewer (e.g., subpoenaing party) and the forensic data may be used to verify the snapshot.

In one example, a method may be implemented as computer executable instructions. Thus, in one example, a computer-readable medium may store computer executable instructions that if executed by a machine (e.g., processor) cause the machine to perform a method that includes creating a snapshot of an operational data collection, creating a hash tree, and providing a forensic data. While executable instructions associated with the above method are described as being stored on a computer-readable medium, it is to be appreciated that executable instructions associated with other example methods described herein may also be stored on a computer-readable medium.

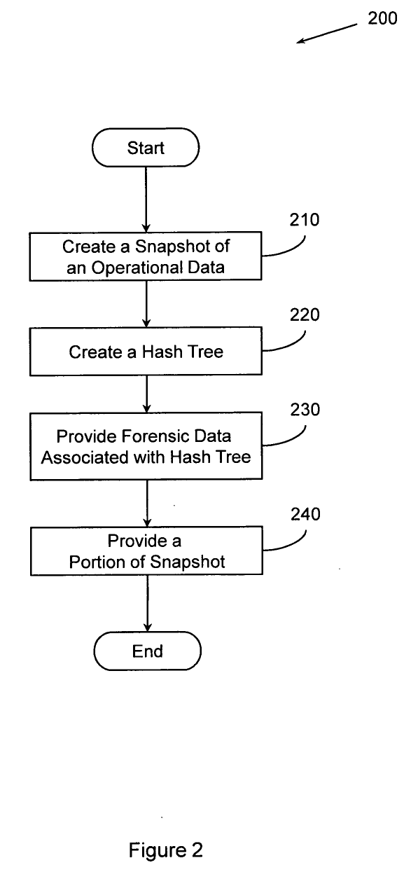

FIG. 2 illustrates a method 200 associated with forensic snapshots. Method 200 may include actions similar to method 100 of FIG. 1. These actions may include creating a snapshot of an operational data at 210, creating a hash tree at 220, and providing a forensic data associated with the hash tree 230.

However, method 200 may also include, at 240, providing a copy of a portion of the snapshot. Providing a copy of a portion of the snapshot at 240 may include providing data associated with the snapshot or a portion of the snapshot. The integrity of the portion of the snapshot may be verifiable based, at least in part, on the previously provided forensic data associated with the hash tree. A portion of the snapshot may be provided, as opposed to a snapshot of the entire data system, to prevent disclosure of non-relevant information to an opposing party. This is useful in cases where initial subpoenas are broad.

In some situations it may be to the benefit of the plaintiff to limit the amount of data disclosed because time may be saved by copying smaller amounts of data and smaller amounts of data require less analysis by the plaintiff. Initial subpoenas often cannot be challenged until the owner of the data system is notified of the demand for information which may not happen until the initial subpoena is served. Disclosure of the root node to an adverse party does not reveal irrelevant data. Additionally, the root node may be used to verify a portion of the snapshot as opposed to the entire snapshot. One branch of the hash tree associated with a portion of the snapshot may be downloaded at a time and the integrity of the portion may be checked against the root node or another node that is at or above the level of the branch of the hash tree. This facilitates the checking of smaller blocks of data by using higher level hashes, for example, the root node.

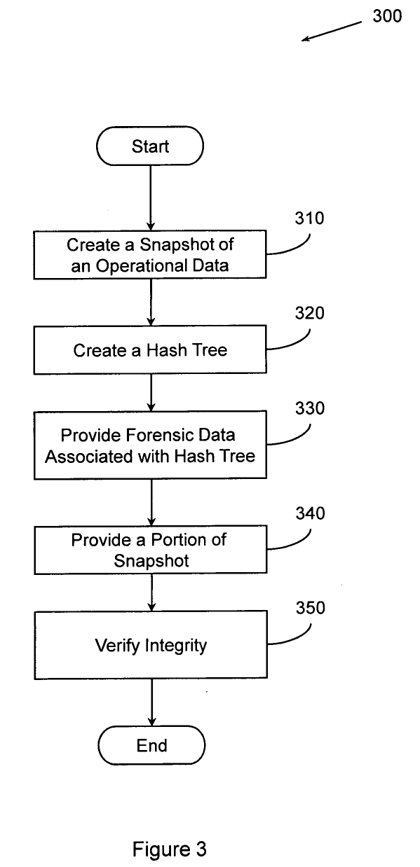

FIG. 3 illustrates a method 300 associated with forensic snapshots. Method 300 may include actions similar to method 200 of FIG. 2. These actions may include creating a snapshot of an operational data at 310, creating a hash tree at 320, providing a forensic data associated with the hash tree at 330, and providing a portion of the snapshot at 340. In one example, the portion of the snapshot that is provided may be selected by a request (e.g., query). In one example, portions of the hash tree may be pre-computed opportunistically based on conditions and/or constraints associated with the operational data collection. For example, during relative idle periods of time, an opportunistic method may pre-compute portions of a hash tree that would be generated if a snapshot were taken. Since some portions of an operational data collection may change relatively infrequently, the opportunistic method may save time by pre-computing portions of a hash tree associated with these unchanging files.

Method 300 may also include additional actions. For example, method 300 may include, at 350, verifying integrity. Verifying integrity at 350 may be performed by using the forensic data. The hash tree and an associated snapshot may be checked with the forensic data that may include the root node, and/or another lower level hash of the hash tree. If the hash tree and the associated snapshot check against the trusted root node of the trusted lower level hash of the hash tree, the hash tree and the associated snapshot may be trusted. The snapshot may be trusted because it may be computationally infeasible to create a manipulated hash tree and associated snapshot that are verifiable by the forensic data.

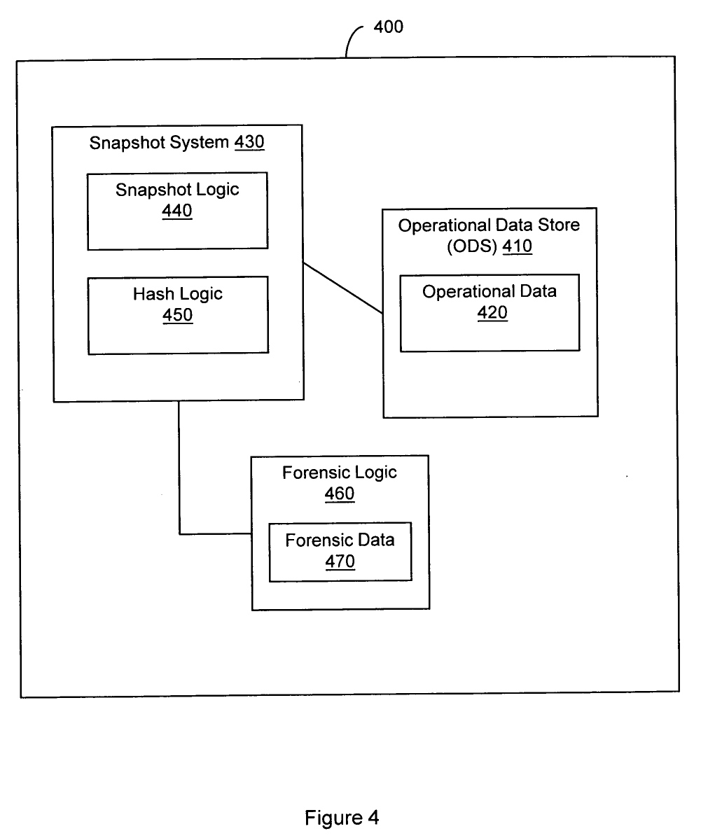

FIG. 4 illustrates a system 400 associated with forensic snapshots. System 400 includes an operational data store (ODS) 410 to store an operational data 420. The operational data 420 may include, for example, a file system, a portion of a file system, a database, a portion of a database, a database table, a set of records, a set of bytes, and so on. System 400 may also include a snapshot system 430. The ODS 410 may be a disk drive or array of disk drives that stores dynamic information that is being updated by applications that utilize the data system.

In one embodiment, the snapshot system 430 includes a snapshot logic 440 to selectively perform and maintain a snapshot. The snapshot may be maintained by tracking and copying the changing blocks of data on a data system as updates are performed to the blocks of data. The tracking and copying may only be performed for blocks of data that are changed after the snapshot is performed. In contrast, data blocks that have not changed after the snapshot was performed do not require copying For example, before a change is allowed to a block of data, a copy-on-write may be performed by copying the frozen data that is to be preserved to a block used only by the snapshot. One skilled in the art will understand that the snapshot logic 440 may be a computer component.

The snapshot system 430 may also include a hash logic 450 to build a hash tree of the snapshot. The hash logic 450 may be operably connected to the ODS 410. In one embodiment, the hash logic 450 includes an opportunistic logic to pre-compute portions of the hash tree of the operational data 420 opportunistically before the snapshot is performed. While some hash trees of snapshots are only computed after the snapshot is performed, other snapshots may be pre-computed or partially pre-computed opportunistically before the snapshot is performed. For example, some data in the ODS 410 may rarely or never change (e.g. static data). A hash tree for this data may be pre-computed opportunistically in the background of the system during non peak system usage before the snapshot is taken. This saves time and system resources when the system is busy by having a portion of the hash tree of the snapshot pre-computed.

In one embodiment, the hash logic 450 is to hash lowest level data blocks of the snapshot to produce intermediate level hashes. The hash logic 450 may also repeatedly grow the hash tree from the bottom up by selectively hashing intermediate level hashes into higher level hashes until a root node is produced. Lowest level data blocks may include a file, a data block, a disk block, a data cluster, and so on. Intermediate level hashes may include, for example, hashes in an intermediate level block of hashes 630 from FIG. 6.

In one embodiment, the unchanged operational data is the operational data 420 that remains static between time periods of pre-computing portions of the hash tree and performing the snapshot. Pre-computing portions of the hash tree may include opportunistically computing those portions of the hash tree. In another embodiment, the hash tree may be computed by a host processor, a disk array controller, and so on.

System 400 may also include a forensic logic 460 to output a forensic data 470 associated with the hash tree. The integrity of the snapshot is verifiable based, at least in part, on the forensic data 470. The forensic logic 460 may also selectively output a portion of the snapshot associated with the portion of the hash tree. The integrity of the portion of the snapshot may be verifiable based, at least in part, on the forensic data 470. The integrity of the portion of data may be verifiable based, at least in part, on the forensic data associated with the previously provided root node of the hash tree.

In one embodiment, the hash tree includes at least one node precomputed by the opportunistic logic. In one embodiment, the forensic data 470 associated with the hash tree may be a root node of the hash tree. In one embodiment, the portion of the snapshot is associated with the operational data 420 when the snapshot is performed. The snapshot may include metadata associated with the operational data 420, and the operational data 420.

In one embodiment, the portion of the operational data 420 is user-selectable. For example, a user may make a request (e.g., query) that controls the selection of the portion of the operational data 420.

A change to data in the ODS 410 may be detectable by comparing two hashes. For example, a difference between the portion of the snapshot provided at an earlier time and an offered snapshot that purports to be an accurate reproduction of the portion of the snapshot provided at that earlier time may be detectable by comparing two hashes. The two hashes may include a first hash that is associated with the forensic data 470 and a second hash that is computed from the offered snapshot.

In one embodiment, system 400 may include a verification logic. The verification logic may be the entity that verifies portions of snapshots. The verification logic may perform the verification based, at least in part, on the forensic data 470.

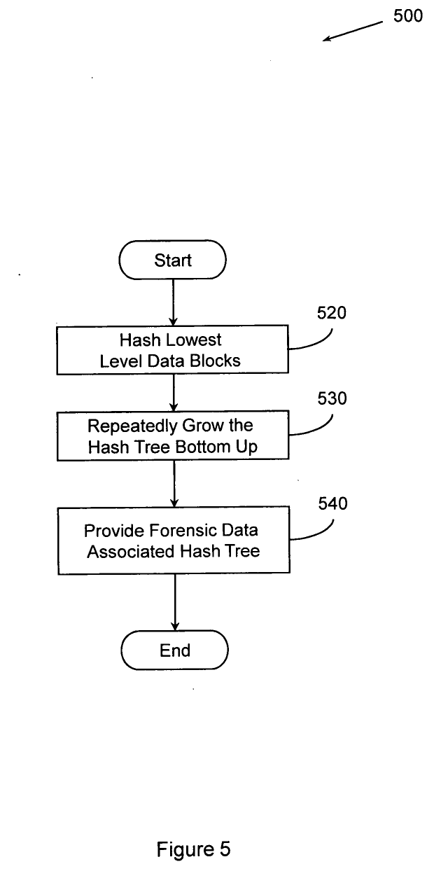

FIG. 5 illustrates a method 500 associated with forensic snapshots. Method 500 may include creating a hash tree. Creating a hash tree may include creating a hash tree of a snapshot of an operational data collection.

Creating a hash tree may include, at 520, hashing lowest level data blocks. Hashing lowest level data blocks at 520 may include hashing the snapshot. This may produce lowest level hashes. The snapshot may be created by selectively performing a copy-on-write, a re-direct on write, a split mirror, and so on, on sub-sets of data from the operational data.

Creating a hash tree may also include, at 530, repeatedly growing the hash tree bottom up. Repeatedly growing the hash tree bottom up at 530 may be performed by selectively hashing lower level hashes into higher level hashes until a root node is produced. One skilled in the art will recognize that producing a root node of a hash tree may include producing a “root node” of a hash tree of a portion of the snapshot instead of the entire snapshot.

Method 500 may also include, at 540, providing forensic data associated with the hash tree. The forensic data may be used to verify the integrity of the snapshot. The forensic data may be a node of the hash tree, the root node of the hash tree, a portion of the hash tree, and so on. The node of the hash tree may be the root node of the hash tree. However, the node may be an intermediate level node of the hash tree below the root node that may verify a portion of the hash tree and an associated portion of the snapshot. The forensic data may allow the verification of a later provided snapshot. Providing a forensic data may allow a data system to create a copy of the snapshot in the background of the system to conserve resources while providing a way (e.g. the forensic data) to later verify the data to determine that it was not manipulated during copying.

FIG. 6 illustrates an example hash tree 600 associated with forensic snapshots. Hash trees may be used to verify the integrity of data stored, handled, and transferred within and between computers. Hash trees may be used to determine that data blocks received from adverse parties are unaltered during the copying of data blocks.

Hash tree 600 includes a lowest level group of data blocks 610. The lowest level group of data blocks 610 may include a file, a set of files, a data block, a disk block, a data cluster, a metadata, a file system structure, and so on.

Hash tree 600 also includes a lowest level group of hashes 620. Hash tree 600 also includes an intermediate level group of hashes 630. A hash from the intermediate level group of hashes 630 may be used to verify the integrity of a portion of a snapshot. An intermediate hash of the intermediate level group of hashes 630 may be a hash of members of the lowest level group of hashes 620.

Hash tree 600 also includes a root node 640. The root node 640 may be at the top of the hash tree 600. One skilled in the art will realize that the hash of the root node 640 may also be called a master hash, a top hash, and so on. A root node 640 may be received from a trusted source, for example, a data system that has been served with a subpoena that quickly provides the root node 640. The speed of production of the root node 640 may prevent an adverse party from manipulating data, thus making the root node 640 trusted. One skilled in the art will realize that a hash from the intermediate level group of hashes 630 or the lowest level group of hashes 620 may also be used as trusted data to write verify a snapshot and/or a portion of a snapshot.

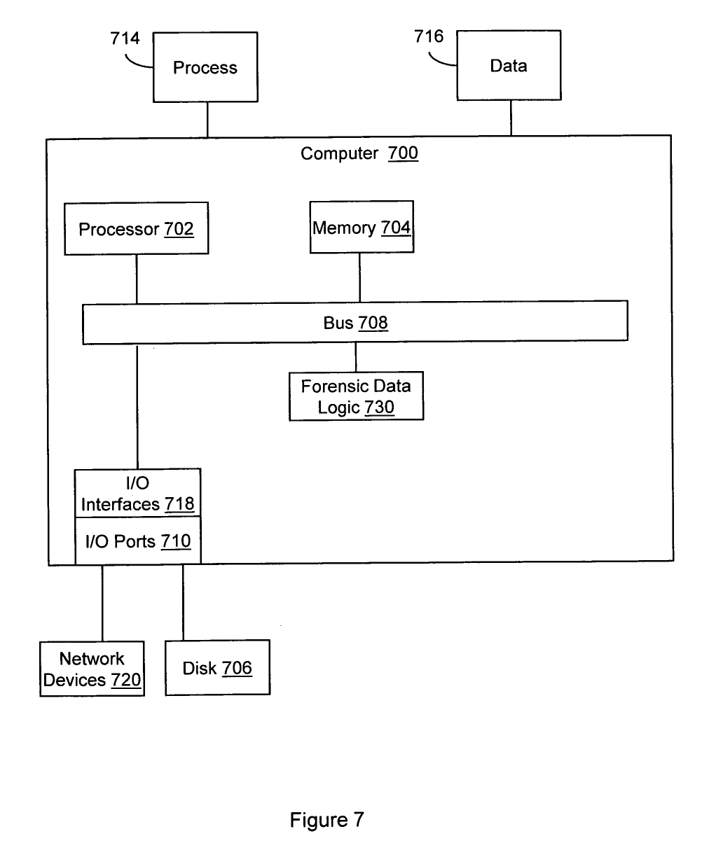

FIG. 7 illustrates an example computing device in which example systems and methods described herein, and equivalents, may operate. The example computing device may be a computer 700 that includes a processor 702, a memory 704, and input/output ports 710 operably connected by a bus 708. In one example, the computer 700 may include a forensic data logic 730 configured to facilitate forensic snapshots. In different examples, the logic 730 may be implemented in hardware, software, firmware, and/or combinations thereof. While the logic 730 is illustrated as a hardware component attached to the bus 708, it is to be appreciated that in one example, the logic 730 could be implemented in the processor 702.

Thus, logic 730 may provide means (e.g., hardware, software, firmware) for creating a forensic snapshot of an operational data by selectively performing and maintaining an immutable copy of sub-sets of data of the operational data via the copy-on-write technique. The means may be implemented, for example, as an ASIC programmed to facilitate forensic snapshots. The means may also be implemented as computer executable instructions that are presented to computer 700 as data 716 that are temporarily stored in memory 704 and then executed by processor 702.

Logic 730 may also provide means (e.g., hardware, software, firmware) for building a Merkle tree of hashes associated with the forensic snapshot. Logic 730 may also provide means (e.g., hardware, software, firmware) for providing a forensic data associated with the Merkle tree. Logic 730 may also provide means (e.g., hardware, software, firmware) for providing the snapshot associated with the Merkle tree. Integrity of the snapshot may be verifiable based, at least in part, on the forensic data.

Generally describing an example configuration of the computer 700, the processor 702 may be a variety of various processors including dual microprocessor and other multi-processor architectures. A memory 704 may include volatile memory and/or non-volatile memory. Non-volatile memory may include, for example, ROM, PROM, and so on. Volatile memory may include, for example, RAM, SRAM, DRAM, and so on.

A disk 706 may be operably connected to the computer 700 via, for example, an input/output interface (e.g., card, device) 718 and an input/output port 710. The disk 706 may be, for example, a magnetic disk drive, a solid state disk drive, a floppy disk drive, a tape drive, a Zip drive, a flash memory card, a memory stick, and so on. Furthermore, the disk 706 may be a CD-ROM drive, a CD-R drive, a CD-RW drive, a DVD ROM, and so on. The memory 704 can store a process 714 and/or a data 716, for example. The disk 706 and/or the memory 704 can store an operating system that controls and allocates resources of the computer 700.

The bus 708 may be a single internal bus interconnect architecture and/or other bus or mesh architectures. While a single bus is illustrated, it is to be appreciated that the computer 700 may communicate with various devices, logics, and peripherals using other busses (e.g., PCIE, 1394, USB, Ethernet). The bus 708 can be including, for example, a memory bus, a memory controller, a peripheral bus, an external bus, a crossbar switch, and/or a local bus.

The computer 700 may interact with input/output devices via the i/o interfaces 718 and the input/output ports 710. Input/output devices may be, for example, a keyboard, a microphone, a pointing and selection device, cameras, video cards, displays, the disk 706, the network devices 720, and so on. The input/output ports 710 may include, for example, serial ports, parallel ports, and USB ports.

The computer 700 can operate in a network environment and thus may be connected to the network devices 720 via the i/o interfaces 718, and/or the i/o ports 710. Through the network devices 720, the computer 700 may interact with a network. Through the network, the computer 700 may be logically connected to remote computers. Networks with which the computer 700 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-readable medium storing computer-executable instructions that when executed by a computer cause the computer to perform a method, the method comprising:
creating a snapshot of an operational data collection;
creating a hash tree from the snapshot; and
providing a forensic data associated with the hash tree, where the forensic data is used to verify that one of, a portion of the snapshot, and a copy of a portion of the snapshot, has remained unchanged since the snapshot was taken.

2. The computer-readable medium of claim 1, where the operational data collection includes metadata of one or more of, a file system structure of a file system, a file system structure of a subdirectory of a file system, and a header of a file.

3. The computer-readable medium of claim 1, where creating the hash tree from the snapshot includes:
hashing data blocks from the snapshot to produce lowest level hashes; and
repeatedly growing the hash tree bottom up by selectively hashing lower level hashes into higher level hashes until a root node is produced.

4. The computer-readable medium of claim 1, the method including:
providing a copy of a portion of the snapshot; and
verifying that the copy of the portion of the snapshot is the same as the original portion of the snapshot was at the time the snapshot was created, where the verifying is based, at least in part, on the forensic data.

5. The computer-readable medium of claim 4, where the portion of the snapshot is selectable by a query.

6. The computer-readable medium of claim 1, the method including pre-computing portions of the hash tree opportunistically before the snapshot is performed.

7. A system, comprising:
an operational data store to store an operational data, the operational data comprising a file system;
a snapshot logic to take a snapshot of a portion of the operational data;
a hash logic to build a hash tree from the snapshot;
and
a forensic logic to output a forensic data associated with the hash tree, where integrity of the snapshot is verifiable based, at least in part, on the forensic data.

8. The system of claim 7, where the portion of the operational data is selectable by a request.

9. The system of claim 7, where the forensic logic is also to output a portion of the snapshot.

10. The system of claim 9, including a verification logic to verify the integrity of the portion of the snapshot.

11. The system of claim 10, where the verification logic is to verify the integrity of the portion of the snapshot based, at least in part, on the forensic data.

12. The system of claim 7, the hash logic comprising an opportunistic logic to pre-compute portions of the hash tree opportunistically before the snapshot is performed.

13. The system of claim 12, where the hash tree includes at least one node pre-computed by the opportunistic logic.

14. The system of claim 11, where a difference between the portion of the snapshot and an offered snapshot that purports to be an accurate reproduction of the portion of the snapshot is detectable by comparing two hashes, a first hash associated with the forensic data, and a second hash computed from the offered snapshot.

15. A method, comprising:
creating a hash tree of a snapshot of an operational data collection, by:
hashing lowest level data blocks from the snapshot to produce lowest level hashes; and
repeatedly growing the hash tree bottom up by selectively hashing lower level hashes into higher level hashes until a root node is produced;
and
providing a forensic data associated with the hash tree, where the forensic data is used to verify integrity of the snapshot.
